(19) United States
(12) Patent Application Publication
(10) Pub. No.: US 2019/0385180 A1
(43) Pub. Date: Dec. 19, 2019

(54) QUALITATIVE ANALYSIS DASHBOARD, SYSTEM AND METHOD

(71) Applicant: Qeysco Pty Ltd, Brisbane, Queensland (AU)

(72) Inventors: Peter Vogel, Brisbane, Queensland (AU); Patricia van Dam, Brisbane, Queensland (AU)

(21) Appl. No.: 16/463,744

(22) PCT Filed: Nov. 29, 2017
(86) PCT No.: PCT/AU2017/051317

§ 371 Date: May 23, 2019

(30) Foreign Application Priority Data
Nov. 29, 2016 (AU) 2016904900

(51) Int. Cl. G06Q 30/02; G06F 9/451

(52) U.S. Cl. CPC G06Q 30/0203; G06F 3/0482; G06F 9/451

(57) ABSTRACT

A qualitative analysis method, system and dashboard are provided. The dashboard is configured to graphically illustrate qualitative data from a plurality of respondents. The dashboard is configured to illustrate data indicative of a perceived actual situation by the respondents and data indicative of a perceived ambition identified by the respondents with reference to a target.

### TECHNICAL FIELD

The present invention relates to qualitative analysis.

### BACKGROUND ART

Surveys and questionnaires are commonly used to capture data relating to a business, including from respondents. In particular, questions are provided to the respondents, upon which the responses are collated and analysed.

In order to simplify the processing of survey results, fixed (multiple-choice) answers are often provided with reference to a scale. For example, a question relating to the safety of a workplace may have fixed answers on a scale from “very safe”, to “very unsafe”.

A problem with such surveys is that the data is generally unreliable. In the context of safety, what one person considers to be a safe environment may be very different to what another person considers a safe environment. Similarly, cultural differences may cause different groups of people to respond differently in light of identical circumstance, meaning that data from the different groups cannot be reliably compared.

As such, interviews, and interview-like surveys, may be used, where the respondents are asked open ended questions, and their results are manually interpreted.

A problem with such interviews is that they are time-consuming and labour-intense, and as such, are often only used on a small group of respondents. Furthermore, due to the subjectivity of interviews, they are prone to bias from the interviewer and human error.

Accordingly, there is clearly a need for improved qualitative analysis systems and methods.

It will be clearly understood that, if a prior art publication is referred to herein, this reference does not constitute an admission that the publication forms part of the common general knowledge in the art in Australia or in any other country.

### SUMMARY OF INVENTION

The present invention is directed to qualitative systems and methods, which may at least partially overcome at least one of the abovementioned disadvantages or provide the consumer with a useful or commercial choice.

With the foregoing in view, the present invention in one form, resides broadly in a dashboard configured to graphically illustrate qualitative data from a plurality of respondents, the dashboard is configured to illustrate data indicative of an actual situation and data indicative of an expected situation of the respondents with reference to a target.

The data indicative of the actual situation may relate to a perceived current situation by the respondents. The data indicative of the expected situation may relate to a perceived ambition (and/or a desire to change) by the respondents.

The qualitative data from the plurality of respondents may comprise of maturity model data. The survey may be generated using maturity model data. Preferably, the survey includes a plurality of non-emotive questions relating to a plurality of areas.

The dashboard may include an actual data element, indicative of at least part of the actual data, and an ambition data element, indicative of at least part of the ambition data.

The dashboard may include a target data element, indicative of at least part of the target data.

The dashboard may include a data element indicative of a difference between actual situation data and/or ambition data with reference to target data.

The dashboard may include data of different time periods, wherein the dashboard enables selective presentation of data according to the time periods.

The dashboard may include data of different time periods, wherein the dashboard enables simultaneous presentation of data corresponding to different time periods.

The dashboard may include a line along which the actual, ambition and target data is graphically represented, the line representing a scale on which the actual, ambition and target data is compared.

The actual, ambition and target data may be graphically represented using different shape elements.

The actual and ambition data may be colour coded according to how far the data is from the target. The actual and ambition data may be colour coded according to whether it is above target, below target or on target.

The actual and ambition data may be averaged over all respondents, or a subset of all respondents.

The dashboard may include a plurality of lines, for each of a plurality of sections, wherein the actual, ambition and target data is graphically presented on each of the lines according to the section.

The dashboard may include a stacked bar chart, illustrating a distribution of actual and/or ambition data with reference to target data.

An element of the stacked bar chart may represent a number of respondents in relation to which actual data is below the corresponding target data. An element of the stacked bar chart may represent a number of respondents in relation to which actual data is above the corresponding target data. An element of the stacked bar chart may represent a number of respondents in relation to which the actual data is in line with the corresponding target data.

Elements of the stacked bar chart may represent ambition data. Elements relating to actual and ambition data may be interleaved.

The dashboard may include a plurality of stacked bar charts. Each of the bar charts may relate to a different subset of the actual and/or ambition data respectively. The subsets may relate to different questions.

The stacked bar charts may be displayed in order according to the distribution.

The stacked bar charts may be aligned graphically according to a difference between a distribution of respondents that are above and below the target.

The dashboard may include an alignment map (or heat map) illustrating a distribution of groups of respondents.

The dashboard may include a knowledge availability (or performance realisation) map for each of a plurality of sections. Alternatively, the dashboard may include a knowledge gap (or performance gap) map for each of a plurality of sections.

The dashboard may include a situation breakdown table, where rows represent groups of respondents, and columns represent areas, and wherein cells are provided at an intersection of rows and columns to illustrate actual and/or ambition data in relation to the associated group and area.

The cells may be colour coded according to a difference between the actual and/or ambition data and the target.

The cells may be grouped according to actual and ambition data.

Preferably, the dashboard is interactive. A manager may be able to select a subset of respondents, upon which the graphical representation of the data on the dashboard is updated accordingly. The manager may be able to select a subset of areas, upon which the graphical representation of the data on the dashboard is updated accordingly.

The manager may be able to select subsets of respondents in a hierarchical manner.

The dashboard may illustrate average and distribution of actual and/or ambition data.

The actual data element and/or the ambition data element may include a spread element indicating the range of answers given in relation to the data indicative of the perceived actual situation or ambition as well as a management target for this question. The actual and/or ambition spread element together may show the value of the average, standard deviation and/or median of all answers given in relation to the data indicative of the perceived actual situation or ambition.

The dashboard may include:

a line along which averaged actual and ambition data is graphically represented, the averaged actual and ambition data averaged over a plurality of respondents; and

a stacked bar chart, illustrating a distribution of actual and/or ambition data over the plurality of respondents.

In another form, the invention resides broadly in a qualitative analysis method including:

receive qualitative data from a plurality of respondents, the qualitative data indicative of an actual situation and an expected situation relating to a plurality of areas;

receive target data that relates to the qualitative data; and

provide a dashboard configured to graphically illustrate data indicative of the actual situation and data indicative of the expected situation with reference to the target.

In another form, the invention resides broadly in a qualitative analysis system including a server, configured to:

receive qualitative data from a plurality of respondents, the qualitative data indicative of an actual situation and an expected situation relating to a plurality of areas;

receive target data that relates to the qualitative data; and

provide a dashboard configured to graphically illustrate data indicative of the actual situation and data indicative of the expected situation with reference to the target.

Preferably, embodiments of the invention provide multiple choice surveys based on qualitative maturity model descriptors and as such do not require a moderator. Qualitative outcomes may be generated due to the questions being asked and the provided objective answers. As such, insights into the respondents' view of current and future states may be determined and compared with an agreed management target. This information may be applicable to any industry, business and subject.

Preferably, embodiments of the present invention may be used with a large respondent group, which provides a high level of statistical accuracy for the data. Embodiments of the invention may provide an automated, objective and unbiased outcome.

Questions may be provided relating to maturity models that span across a large number of areas of business, and selected therefrom to be applied to any specific subject or business requirement. Improvement steps may also be provided that are based on maturity level improvements and incorporated into the system and dashboard and can be easily tailored to the specific business/industry and/or specific requirements.

Detailed benefits per maturity model step may be incorporated into the system and show the value for specific improvements. An interactive benefits realisation graph may be provided that managers can use to decide on which improvements to make.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a schematic of a qualitative analysis system, according to an embodiment of the present invention;

FIG. 2 illustrates a screenshot of a question screen of the system of FIG. 1, according to an embodiment of the present invention;

FIG. 3 illustrates a screenshot of a results overview screen of the system of FIG. 1, according to an embodiment of the present invention;

FIG. 4 illustrates a screenshot of an enlarged portion of the results overview screen of FIG. 3, illustrating a menu in further detail;

FIG. 5 illustrates a screenshot of a pop-up filter details screen of the results overview screen, for a structure filter type, according to an embodiment of the present invention;

FIG. 6 illustrates a screenshot of a situation breakdown screen of the system of FIG. 1, according to an embodiment of the present invention;

FIG. 7 illustrates a screen shot of a Road to Target screen of the system of FIG. 1, according to an embodiment of the present invention;

FIG. 8 illustrates a screenshot of a knowledge or performance screen of the system of FIG. 1, according to an embodiment of the present invention;

FIG. 9 illustrates a screenshot of a respondent feedback screen, according to an embodiment of the present invention;

FIG. 10 illustrates a screenshot of a first questionnaire comparison/continuous improvement screen of the system 100, according to an embodiment of the present invention;

FIG. 11 illustrates a screenshot of a second questionnaire comparison/continuous improvement screen of the system 100, according to an embodiment of the present invention;

FIG. 12 illustrates a screenshot of a third questionnaire comparison/continuous improvement screen of the system 100, according to an embodiment of the present invention;

FIG. 13 illustrates a screenshot of a fourth questionnaire comparison/continuous improvement screen of the system 100, according to an embodiment of the present invention;

FIG. 14 illustrates a screenshot of a fifth questionnaire comparison/continuous improvement screen of the system 100, according to an embodiment of the present invention; and

FIG. 15 illustrates a screenshot of a pockets of excellence screen, according to an embodiment of the present invention;

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

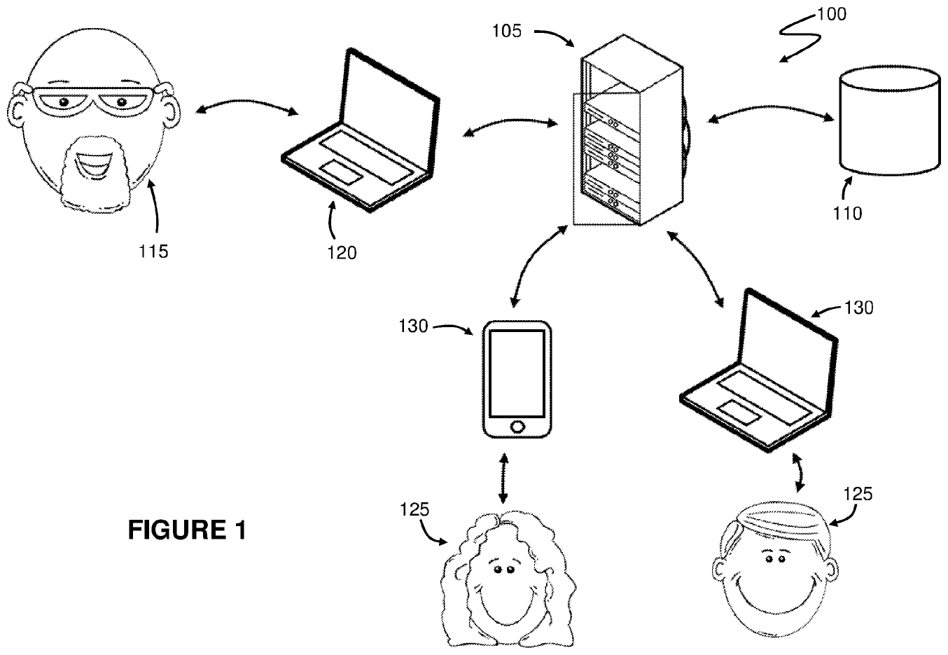

FIG. 1 illustrates a schematic of a qualitative analysis system 100, according to an embodiment of the present invention. The qualitative analysis system 100 is particularly suited to a business transformation or change management program/project, to focus resources where they are most needed, but can also be used to show how businesses are performing within their industry and sector, how they can improve, and what value/benefit is associated therewith.

The system 100 includes a server 105, which is coupled to a library 110 which includes a plurality of questions relating to a multitude of business areas, and a plurality of non-emotive situational descriptions associated with each of the questions that comprise answers to these questions.

The questions and answers are advantageously part of standardised maturity models, which allows an organization to have its methods and processes assessed according to management best practice, and against a clear set of benchmarks. In such case, each of the answer options is associated with a particular maturity level.

In use, a manager 115 communicates with the server 105 using a manager device 120, to define a business assessment survey. This may be achieved by selecting questions from the library 110 which are relevant to the survey, selecting employees or other persons (respondents) to which the survey is targeted (e.g. if not all staff, or other predefined group is targeted), and inputting targets associated with each of the questions.

The targets define a desired answer, and as such, a desired maturity level, for each of the questions. As such, the manager 115 is able to set different targets for each area of the business. As an illustrative example, the manager may set a high target for questions relating to innovation, if there is a goal for the business to be very innovative, and a lower target for quality management as it relates to their business strategy.

The manager 115 is able to prioritise the business areas and the questions within the business area to show what areas have a higher importance to the business. As an illustrative example, safety may be the business area with the highest priority and the question about people safety within safety may have the highest priority.

According to certain embodiments, the targets are at least in part generated by the server 105 according to one or more inputs by the manager 115. This is particularly useful if there are many questions relating to similar themes, as the manager 115 does not need to manually enter a target for each question.

The skilled addressee will readily appreciate that the manager need not be a manager in the traditional business sense, but instead may be a consultant engaged by the business, or anyone responsible for the qualitative analysis being performed.

Once the questions have been defined, and the respondents are selected, details of the questions are sent to respondents 125, for access by their respective respondent devices 130.

In particular, the respondents 125 log onto the server 105, for example through a website, using their employer devices 130, and retrieve a graphical user interface including the questions, respond to the questions, and submit their responses back to the server 105, as outlined below.

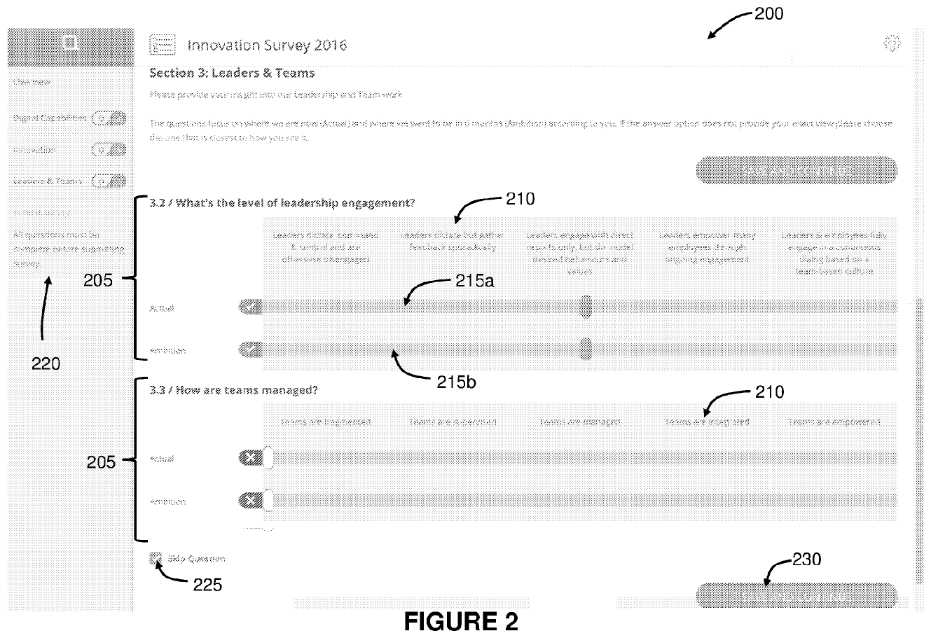

FIG. 2 illustrates a screenshot 200 of a question screen of the system 100, according to an embodiment of the present invention. The question screen is provided to the manager 115 as part of the graphical user interface that enables respondents 125 to receive the questions, and submit their response thereto.

The question screen includes a plurality of question elements 205, each associated with a plurality of answers 210. As described above, the answers are specific to the question and are defined by the levels of a maturity model.

The answers 210 are substantially objective, where possible, to reduce an impact of a respondent's subjectivity. This is particularly useful when questions are asked of various cultures and in various regions, as there can be a wide variation subjectively between the different groups of respondents.

For example, for a question “to what extent does the organisation make an effort to improve?”, the answers may include various options from “the organisation makes no effort to make changes” to “the organisation seeks opportunities to improve which are innovative and might sometimes be radical”.

Similarly, for a question “what's the level of leadership management?”, the answers may include various options from “leaders dictate, command & control and are otherwise disengaged” to “leaders & employees fully engage in a continuous dialogue based on a team-based culture”.

First and second slide bars 215a, 215b are provided in association with each of the questions, to enable the respondents 125 to answer the question. The first slide bar 215a is associated with the respondent's actual response to the question, and the second slide bar 215b is associated with an ambition of the respondent with respect to the question.

The slide bars 215a, 215b, although placed in association with a plurality of discrete answers 210, is not limited to those discrete answers. For example, the respondents 125 may leave the slide bar between two answers if he or she feels a desire to provide an answer between two pre-defined answers.

The ambition may be defined with reference to a particular time point (e.g. 4 months from now). If a particular time point is desired, the graphical user interface will generally represent this to provide an indication of same to the respondent.

While the term “ambition” is used, the skilled addressee will readily appreciate that this does not necessarily relate to any individual or group ambition, but instead to where it is expected that the business or group will be at the particular time point.

When the respondents 125 answer a question by dragging the slide bars 215a, 215b, a colour of the slide bar is adjusted. For example, a slide bar that has not been used may be coloured red, and a slide bar which has been used may be coloured green. This provides the respondents 125 with a fast visual overview of what questions have been answered, and which haven't, which may increase compliance with the questions, particularly if the respondent chooses to answer questions out of order.

The question screen includes a progress overview menu 220, which provides an indication of the progress of the questions by the respondent. In particular, the questions are split into a plurality of groups, each relating to an area such as digital capabilities, innovation, and leaders & teams, and the progress overview menu 220 illustrates an indication of the progress through each of the groups.

The progress menu 220 may be selectable, to enable the respondent to navigate between questions based upon a question group. This is particularly useful if the respondent has a specific preference in relation to the order in which he or she answers the questions.

As each group of questions is completed, the next group of questions is displayed. In some cases the manager 115 may allow a question to be skipped. In that case, a skip question button 225 is also provided, which the respondent can tick in case a respondent wishes to skip the question.

A save and continue button 230 is provided to enable a respondent to save his or her responses, and/or to continue to another group of questions.

Finally, a submit button is provided after all questions have been answered to enable the respondent to submit all responses.

Once all answers are submitted, they are collated by the server 105, and reports and/or analytics are generated for the manager 115, as outlined below.

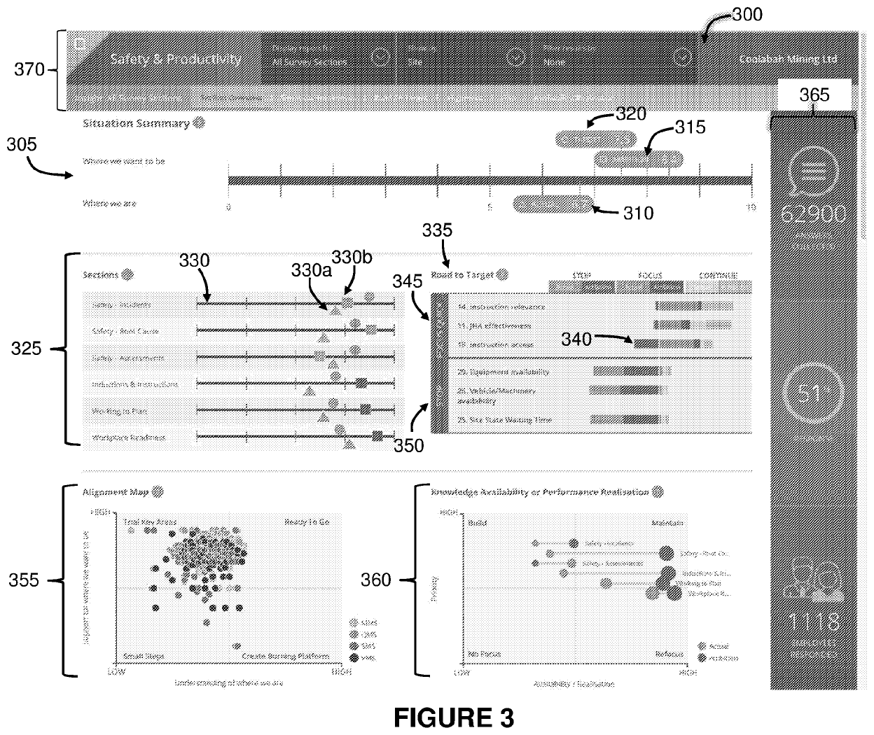

FIG. 3 illustrates a screenshot 300 of a results overview screen of the system 100, according to an embodiment of the present invention. The results overview screen may comprise part of a dashboard for graphically illustrating the results.

The results overview screen includes a summary bar 305, which includes an actual element 310, which indicates the actual state (as perceived by the respondents) based upon the results, an ambition element 315, which indicates the ambition based upon the results, and a target 320.

The actual element 310 and the ambition element 315 may be generated by averaging all actual and ambition responses from all respondents. The target element 320 may be generated by averaging all targets provided by the manager 115. As such, the summary bar provides an indication of average of all the answers for all of the respondents.

The actual 310, ambition 315 and target 320 elements may be colour coded. The colour coding may be generated according to a difference between the actual and ambition data to the target value. For example, an actual element 310 that is far from the target 320 may be coloured red. Similarly, an ambition element 315 may be colour coded orange if it is a smaller distance from the target. An actual element 310 and/or an ambition element 315 may be colour coded dark green if it is a distance beyond the target. The target element 320 may be illustrated green for reference.

The results overview screen includes a section overview element 325, which provides an overview for each of a plurality of sections. The sections may correspond with the groups of questions, or may comprise separate groupings. Examples of sections include “safety—incidents”, “safety—root cause”, “safety—assessments”, “inductions and instructions”, “working to plan” and “workplace readiness”.

Each section is associated with comprises an element bar 330, much like the summary bar 305, with actual 330a, ambition 330b and target 330c elements, corresponding to average actual, ambition and target values for each of the respective section. In order to reduce space, the actual, ambition and target elements 330a-330c are shape coded (e.g. actual—triangle, ambition square, target—circle).

Furthermore, the actual, ambition and target elements 330a-330c are colour coded much like the elements 310-330 above, to illustrate how close they are to the target.

As such, the section overview element provides a simple to read overview for each of the sections, and in particular in relation to the actual, ambition and target. This enables the manager 115 to quickly determine that a section is over (or under) ambitious, or deviates from the other sections, and take appropriate investigative or remedial actions.

The results overview screen includes a road to target element 335, which includes a plurality of stacked bar charts 340 illustrating a distribution of actual and ambition responses relative to the corresponding target for each of a plurality of extremes. In particular, the bar charts 340 include a stop grouping, wherein an actual or ambition response is higher than target, a focus quick wins grouping, wherein an actual response is lower than target and an ambition is close to the target, a focus more complex grouping wherein an actual and an ambition response are lower than the target or an actual is close to the target and an ambition is lower than the target, and a continue grouping, wherein an actual and ambition response are close to the target.

Each of the groupings is colour coded (e.g. purple for stop, blue for focus, and green for continue), and shaded (e.g. light/dark) for actual and ambition results respectively, to simplify interpretation of the road to target element.

The road to target element 335 may include a focus quick wins sub-element 345, which provides the bar charts 340 for elements most requiring “focus”, and/or a focus more complex sub-element (not depicted) for more complex elements requiring “focus”, and/or a continue sub-element (not depicted) for elements that do not require immediate attention and/or a stop sub-element 350, which provides bar charts 340 for the elements most needing to “stop”.

The results overview screen includes an alignment map element 355, illustrating a distribution of respondents in relation to a shared understanding of where they are, and support for where they want to be.

The distribution of respondents is illustrated as an alignment map, which, much like a heat map, illustrates the distribution of respondents graphically, and for a plurality of different respondent classes. Each of the classes of respondents is illustrated with a different colour.

As such, the manager 115 viewing the alignment map is able to see if groups of respondents are generally ready to go (i.e. have a good understanding of where they are and support for where they want to be), or otherwise.

The results overview screen further includes a knowledge availability element 360 (or performance realisation element). In particular, responses are mapped according to priority (e.g. input by the manager 115) in relation to a question or group of questions, and an availability/realisation.

Accordingly, the responses can be grouped into a build group (where priority is high, but availability is low), a maintain group (where priority is high and availability is high), a no focus group (where priority and availability are low), and a refocus group (where priority is low and availability is high).

A response overview strip 365 is provided, which provides details a number of answers collected, a response rate, and a number of respondents that have responded. As such, the manager 115 viewing the response overview strip is able to get a quick overview of the response rates, and associated data, relating to the survey.

Finally, a menu 370 is provided to enable the manager 115 to navigate between different screens of the system, and to filter data using filter elements. The filter elements include a section selection menu, a division selection menu and a filter menu, to enable the manager 115 to generate reports and filter results based upon respondent selections.

Navigation components of the menu 370 enable managers to navigate to (and between) a section overview screen, a situation breakdown screen, a road to target screen, an alignment screen, a knowledge gap screen, and an availability/realisation screen.

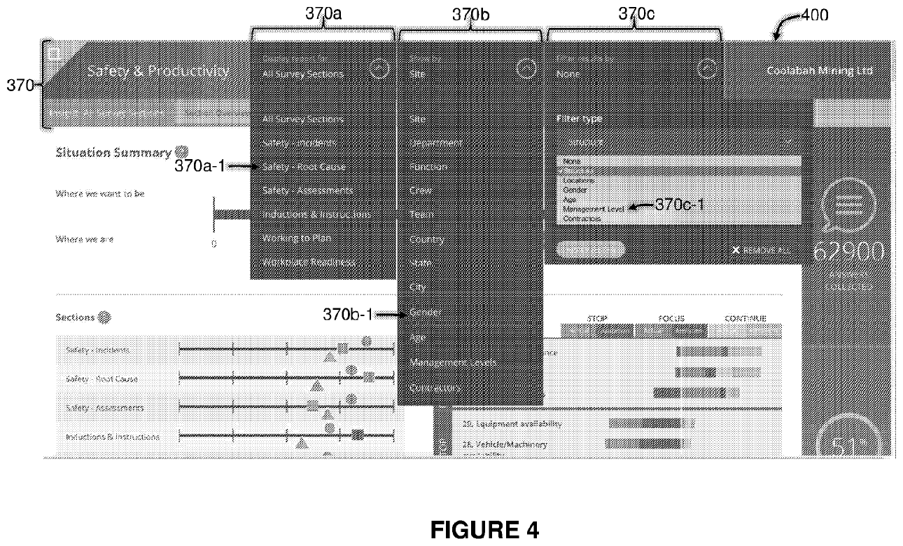

FIG. 4 illustrates a screenshot of an enlarged portion of the results overview screen of FIG. 3, illustrating the menu 370 in further detail.

A section selection menu component 370a of the menu 370 includes section elements 370a-1 enabling the manager 115 to generate a report based upon a specific section element, or an all sections element, e.g. all survey sections, a safety—incidents section, a safety—root cause section, a safety—assessments section, an inductions and instructions element, a working to plan element, and a workplace readiness element.

A division selection menu component 370b includes division elements 370b-1 enabling the manager 115 to generate a report based upon various divisions, including an organisational structure division element that comprises of the specific organisational levels defined by a company, e.g. a site division element, a department division element, a function division element, a crew division element, a team division element; specific geographical levels including a country division element, a state division element, a city division element, and other geographical elements defined by the organisation including e.g. a suburb element and a building element; a gender division element, an age division element, a management level division element and contractor division element.

Finally, a filter menu component 370c includes a filter type drop down menu, which enables the manager 115 to generate reports and filter results based upon various filter type elements 370c-1, including a structure, a location, a gender, an age, a management level and a contractors type.

Upon selection of one of the filter types, a pop-up filter details screen is provided, depending on the selection, enabling the manager 115 to define the filter, as described below.

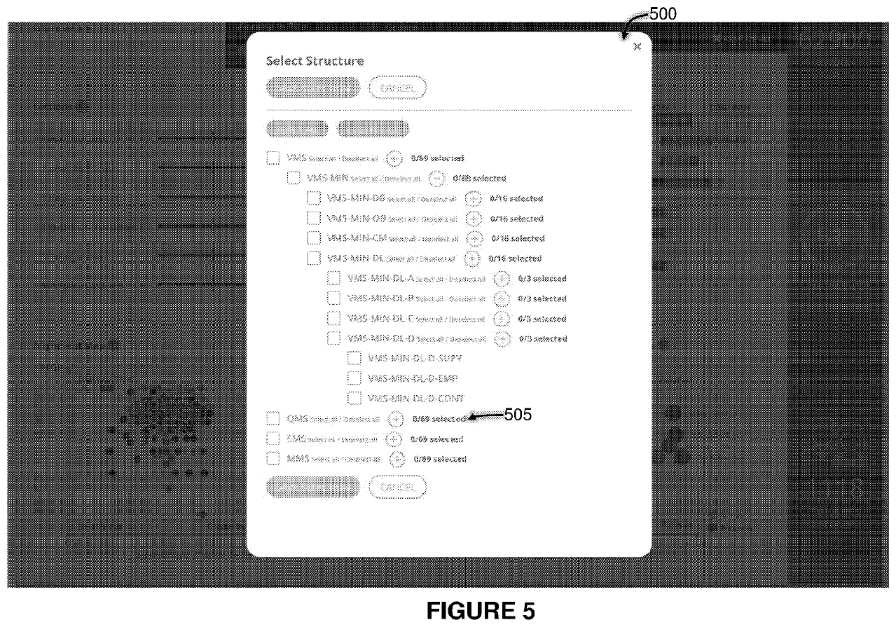

FIG. 5 illustrates a screenshot 500 of a pop-up filter details screen, for a structure filter type, according to an embodiment of the present invention.

A structure of the business is provided in a layered form, including a plurality of business structure elements 505, each associated with a checkbox 510. Each of the business structure elements 505 relates to a different part of a business according to the business structure, and thus enables the manager 115 to define which parts of the business are selected for further review. The checkboxes 510 enable the manager 115 to select a plurality of different parts of the business structure to generate a report, and on a plurality of different levels. As a result, a subset of respondents is chosen according to the selected structure, and the dashboard is updated according to the chosen subset.

Similar pop-up filter details screens are provided for the different filter type elements.

By using the menu 370, the manager 115 is able to drill down onto specific areas for more detailed analysis, as required. As such, the manager 115 is able to quickly identify areas requiring particular attention (or where there are additional resources), and take action accordingly.

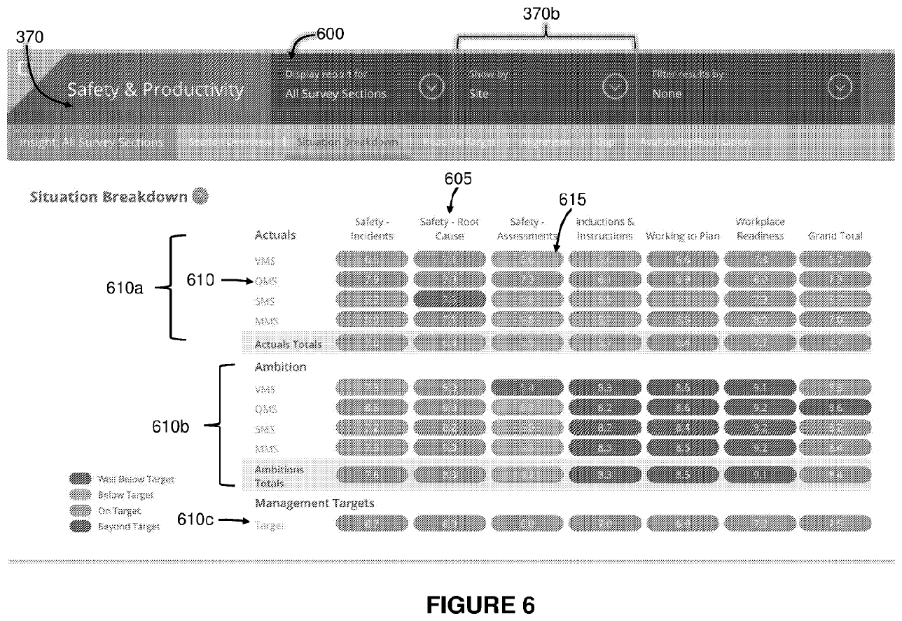

FIG. 6 illustrates a screenshot 600 of a situation breakdown screen, according to an embodiment of the present invention.

The situation breakdown screen includes a plurality of columns 605 relating to each of a plurality of sections, including e.g. “safety—incidents”, “safety—root cause”, “safety—assessments”, “inductions and instructions”, “working to plan” and “workplace readiness”.

The situation breakdown screen further includes a plurality of rows 610, relating to the chosen division selection menu component 370b, e.g. the structure of the business element “Site”. The rows 610 are grouped according to actual rows 610a and ambition rows 610b, to enable the manager 115 to distinguish there between. Furthermore, a management target row 610c is provided as reference.

Each cell 615 is associated with a row and column and has a numerical value displayed thereon representative of the associated survey data. The cell is colour coded to illustrate whether the data is far below target (e.g. red), below target (e.g. orange), on target (e.g. green) or beyond target (e.g. dark green).

The management target row 610c is illustrated in green for reference.

By using the colour coding on the cells 615, the manager 115 is able to quickly get an overview of the areas and structure that are well below target (or otherwise deviating from the norm), and take action or investigate further based thereon.

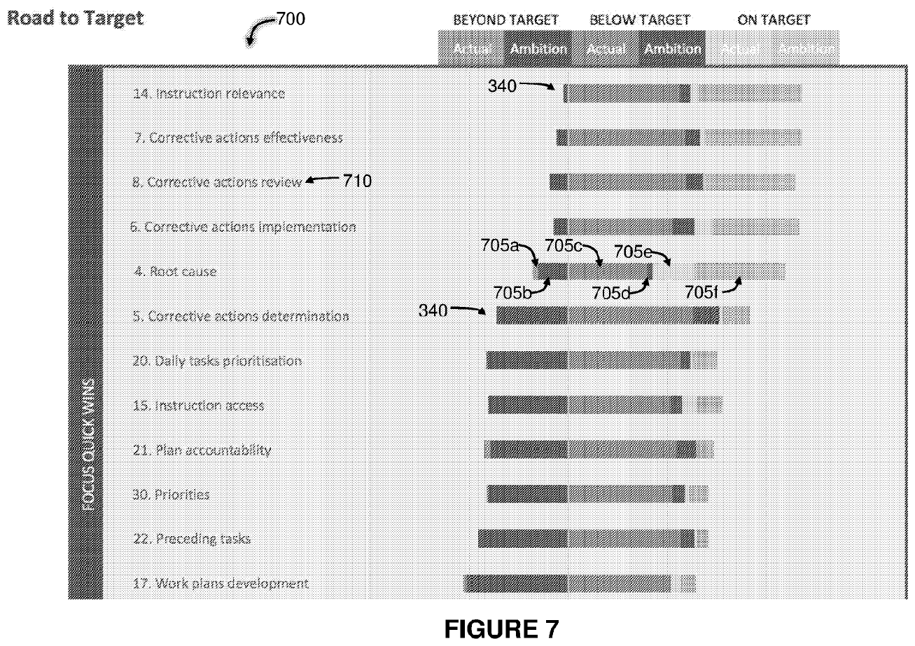

FIG. 7 illustrates a screenshot 700 of a road to target screen, according to an embodiment of the present invention. The road to target screen is similar to the road to target element 335, but includes more elements (and thus more stacked bar charts 340), i.e. numbers and descriptors for all questions that are included in the survey.

As best illustrated in FIG. 7, the bar stacked bar charts 340 include an actual beyond target element 705a, an ambition beyond target element 705b, an actual below target element 705c, an ambition below target element 705d, an actual on target element 705e, and an ambition on target element 705f.

Each of the actual beyond target element 705a, ambition beyond target element 705b, actual below target element 705c, ambition below target element 705d, actual on target element 705e, and ambition on target element 705f are colour coded to assist the manager 115 in quickly identifying each of the elements in the stacked bar charts 340.

The stacked bar charts 340 are sorted based upon a distribution of the different sub-elements, and as such, simplifies the task of the manager 115 in identifying extremes in the results data.

Bar charts are aligned according to a boundary between beyond and below target data, which yet further simplifies the process of identifying groups of elements that are extreme.

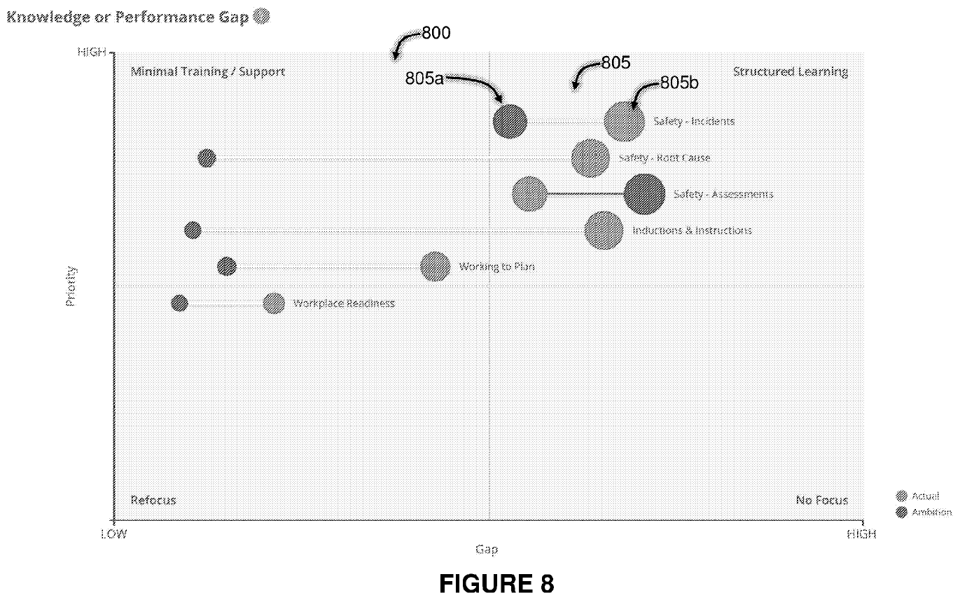

Finally, the elements each include a textual description 710 to enable the manager 115 to get a quick overview of what the element relates. FIG. 8 illustrates a screenshot 800 of a knowledge or performance screen, according to an embodiment of the present invention. The knowledge gap screen is the reverse of the knowledge availability element 360, and is enlarged to provide further detail.

Includes a plurality of knowledge or performance gap elements 805, relating to each of a plurality of sections, including e.g. “safety—incidents”, “safety—root cause”, “safety—assessments”, “inductions and instructions”, “working to plan” and “workplace readiness”.

Each knowledge or performance gap element 805 is split into two sub-elements, namely an actual sub-element 805a, and an ambition sub-element 805b, to enable the manager 115 to quickly and easy compare sections.

The knowledge or performance gap elements 805 are sorted based upon priority on one axis, and based upon a gap on another axis. As the gap may be different for actual and ambition data, the sub-elements 805a, 805b are each placed along the gap axis according to the corresponding gap.

An alignment map screen (not illustrated), similar to the alignment map element 355, but enlarged to provide further detail, is also provided.

According to certain embodiments, the qualitative analysis system 100 includes multiple languages. In particular, the user interfaces described above, text of e-mail invites and reminders, sections of questions, questions and their relevant answers, may be provided in a variety of languages.

When creating a questionnaire, a consultant (or the manager 115) may choose which languages will be made available, and enter associated translations of text in the applicable languages. In this regard, a default language may be associated with a respondent, and as such, all information provided to the respondent may be automatically provided in their default language.

If the translation to the respondents preferred language is not available, the system defaults to English. This applies to all text used in interaction with the respondent.

While entering data into a user interface, the respondent may change the language to cause that user interface to change language. In such case, the default language for the respondent may also change at that time.

All answers are collated and reported on, irrespective of the language used when they were entered.

After a questionnaire has been closed (i.e. when respondents can no longer respond to the questionnaire), respondents that have responded may receive a link to a page that displays the data that they have submitted, with reference to data of other respondents, such as their team, department and/or entire organisation. When configuring the questionnaire, the hierarchical level(s) used for comparison (e.g. team, sub-department, department) may be selected.

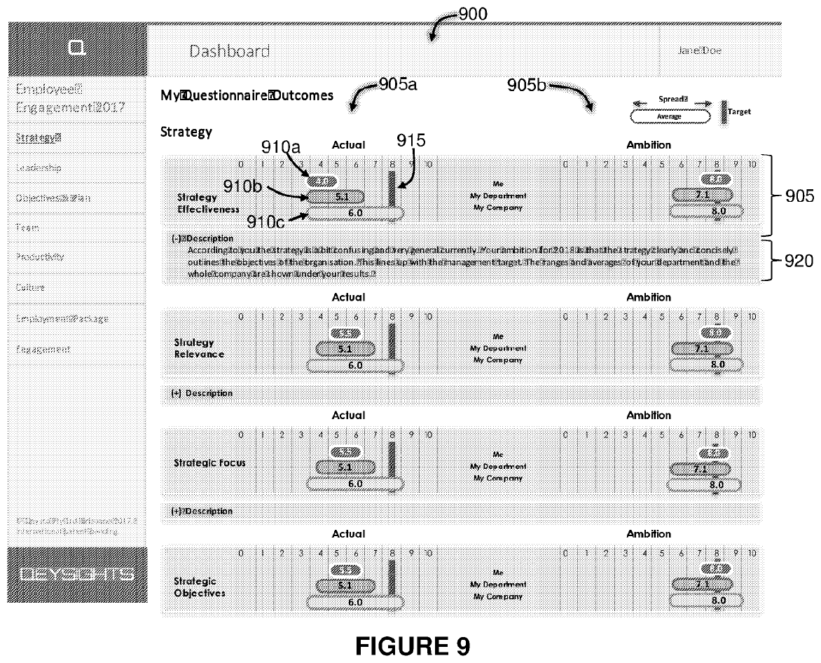

FIG. 9 illustrates a screenshot 900 of a respondent feedback screen, according to an embodiment of the present invention. The respondent feedback screen includes a plurality of questionnaire elements 905, each split into an actual portion 905a and an ambition portion 905b.

Each of the actual portion 905a and ambition portion 905b includes a plurality of outcome elements, including a respondent outcome element 910a, a department outcome element 910b, and a company outcome element 910c. The respondent outcome element 910a indicates a response of the respondent, and the department outcome element 910b and the company outcome element 910c indicate a spread and average, standard deviation and/or median for the department and the company respectively. The spread is the range of answers given by all relevant respondents, and may correspond to a range of the lowest to highest answers given, potentially with outliers (i.e. answers at the extremes) removed.

As such, the department outcome element 910b and the company outcome element 910c not only show the average of the department and company, but also an indication of how much variation was in the answers using the spread, the standard deviation and/or the median.

A target element 915 is displayed in association which each group of respondent, department and company outcome elements 910a-910c, which enables the user to quickly see a difference between the outcome elements and an associated target.

Each questionnaire element 905 is associated with an outcome description element 920, which provides a description of the outcomes. The description of the outcomes is textual and is automated as there are a definitive number of outcome combinations. The outcome description element 920 can be opened and closed (minimised or maximised) according to user input.

In addition to being able to illustrate data from a one-off questionnaire, the system described above is particularly useful for long term evaluation, where questionnaires are run repeatedly and the results are compared.

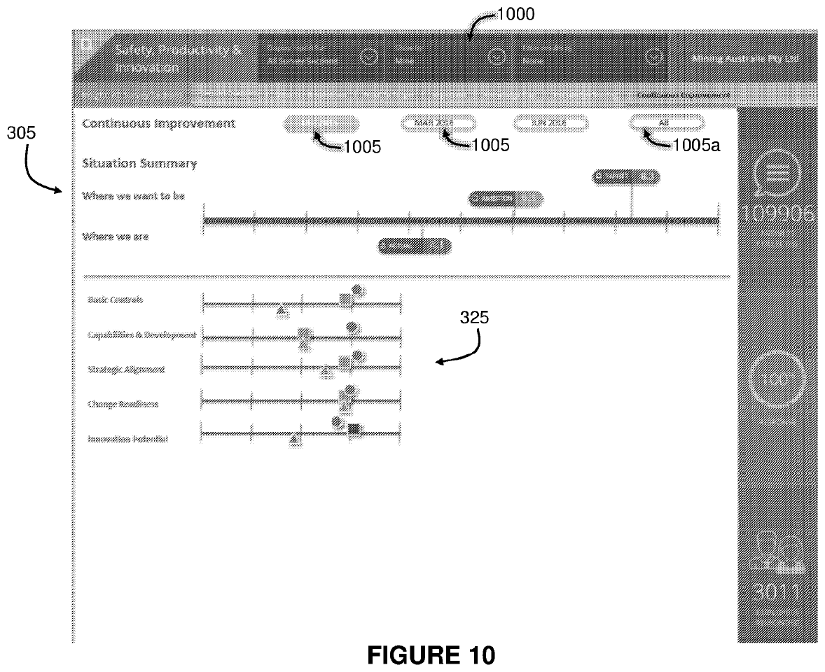

FIG. 10 illustrates a screenshot 1000 of a first questionnaire comparison/continuous improvement screen of the system 100, according to an embodiment of the present invention. The first questionnaire comparison/continuous improvement screen includes a summary bar 305 and a section overview element 325, like that shown in FIG. 3, and a plurality of questionnaire time buttons 1005.

Each of the questionnaire time buttons 1005 is associated with a questionnaire time (e.g. December 2015, March 2016), and selection of a particular questionnaire time button 1005 causes the summary bar 305 and a section overview element 325 to show data corresponding to the questionnaire at the associated questionnaire time.

As such, the user may navigate between the different time periods and get an overview of how the responses have changed over time.

An all time button 1005a is also provided, which when selected, causes the results of all questionnaires to be presented together.

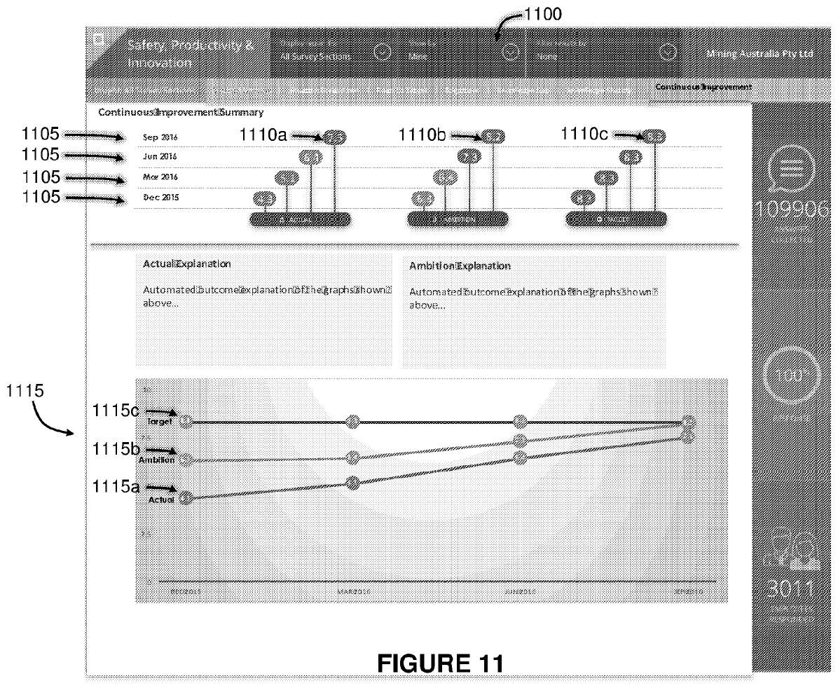

FIG. 11 illustrates a screenshot 1100 of a second questionnaire comparison/continuous improvement screen of the system 100, according to an embodiment of the present invention. The second questionnaire comparison screen illustrates response data relating to a plurality of different questionnaires.

In particular, the second questionnaire comparison/continuous improvement screen includes a plurality of row elements 1105, each corresponding to a questionnaire at a different period in time. Each row element is then associated with an actual element 1110a, an ambition element 1110b, and a target element 1110c.

Each of the actual elements 1110a, each of the ambition elements 1110b, and each of the target elements 1110c are grouped together. As such, the user is able to quickly and easily see trends and changes across the different questionnaires (and thus over time).

The second questionnaire comparison/continuous improvement screen further includes a graph 1115, which plots the response data of the actual, ambition and target elements 1110a-c over time. The graph uses and shows the exact same information as the plurality of row elements 1105 but in a linear fashion to allow for the view of the improvement of the actuals, ambition against the target over time using actual, ambition and target elements 1115a-c. While the target elements 1115c are shown as being static, the skilled addressee will readily appreciate that the target can be updated each year if required.

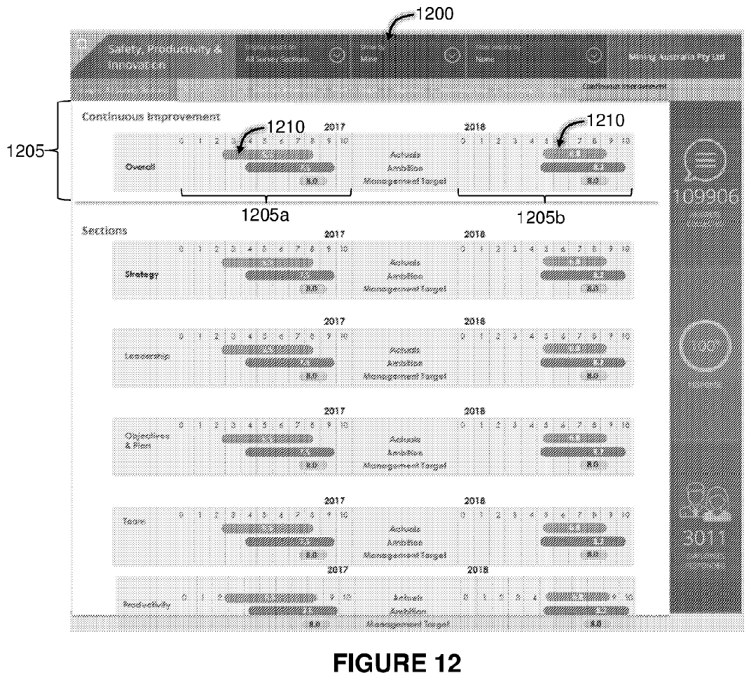

FIG. 12 illustrates a screenshot 1200 of a third questionnaire comparison/continuous improvement screen of the system 100, according to an embodiment of the present invention.

The third questionnaire comparison/continuous improvement screen includes a plurality of questionnaire elements 1205, each split into a first time period 1205a (e.g. 2017), and a second time period 1205b (e.g. 2018). Each of the first time periods 1205a and the second time periods 1205b includes a plurality of outcome elements 1210, much like the outcome elements of FIG. 9, including an actual and ambition outcome element, and a management target. The actual and ambition outcome elements indicate a spread and average relating to the responses, much like as shown in FIG. 9.

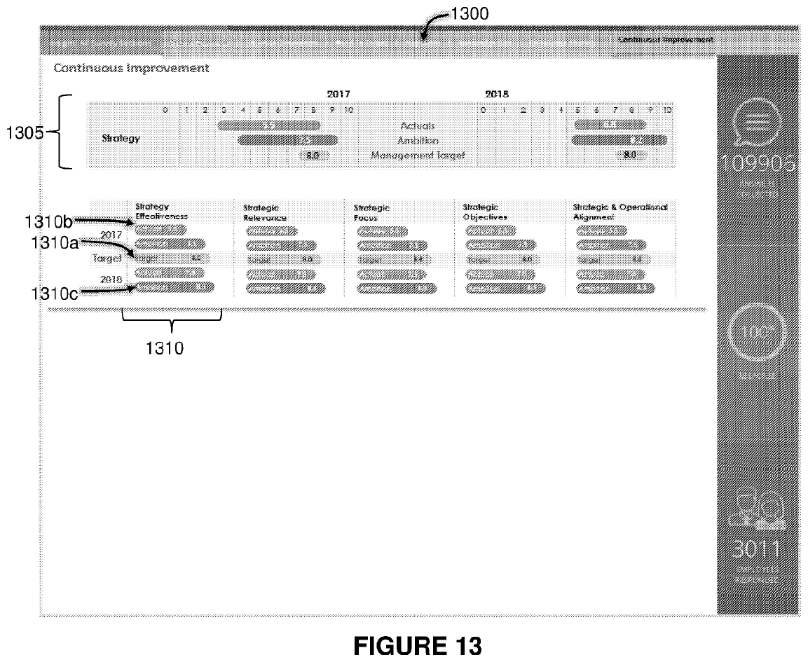

FIG. 13 illustrates a screenshot 1300 of a fourth questionnaire comparison/continuous improvement screen of the system 100, according to an embodiment of the present invention. The fourth questionnaire comparison screen includes a questionnaire element 1305, much like the questionnaire elements 1205, and a plurality of sub-elements 1310.

Each of the sub-elements 1310 relates to a sub-category that corresponds to the questionnaire element 1305, and includes a target element 1310a, and actual and ambition elements 1310b, 1310c for the first and second time periods.

As such, the fourth questionnaire comparison/continuous improvement screen not only provides a good overview of a particular questionnaire element 1305, but also details of the sub-elements 1310, which enables the user to identify specific issues (or areas of excellence) that relate to the questionnaire element 1305.

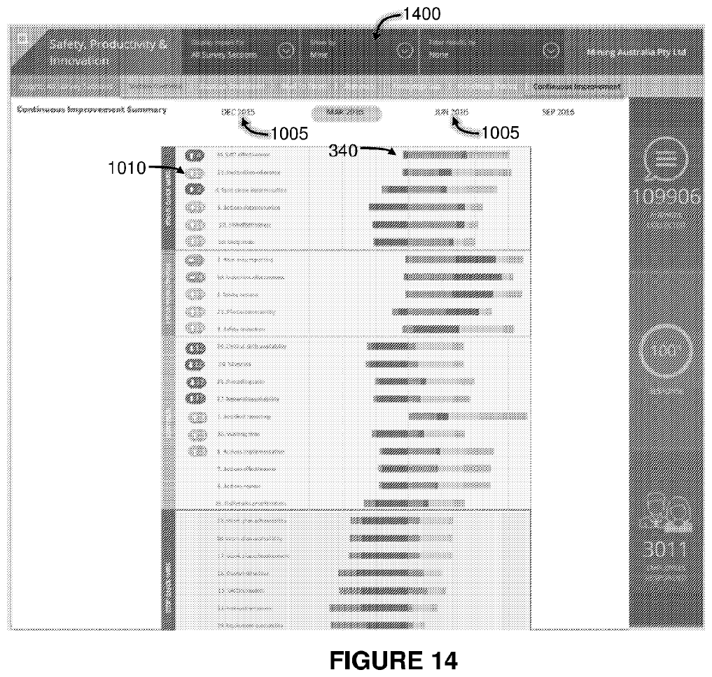

FIG. 14 illustrates a screenshot 1400 of a fifth questionnaire comparison/continuous improvement screen of the system 100, according to an embodiment of the present invention. The fifth questionnaire comparison/continuous improvement screen is similar to the road to target screen of FIG. 7, but includes questionnaire time buttons 1005, enabling the user to update the stacked bar charts 340 according to a time period.

The stacked bar charts 340 may include a change summary element 1010, associated with an aspect of the bar chart. As an illustrative example, the change summary element 1010 may indicate that an element of the bar chart 340 has moved up or down by a particular amount since the previous period.

As such, the fifth questionnaire comparison/continuous improvement screen not only illustrates a distribution of responses, but also clearly indicates changes within that distribution, which enables a user to gauge process of a transformation effort, for example, over time.

In summary, the questionnaire comparison screens described above are particularly useful when a questionnaire is run several times, which may be at any time interval after the initial questionnaire, to measure the improvement of an organisation. This in turn enables the user to see which areas are changing at a desired rate, and which ones are not.

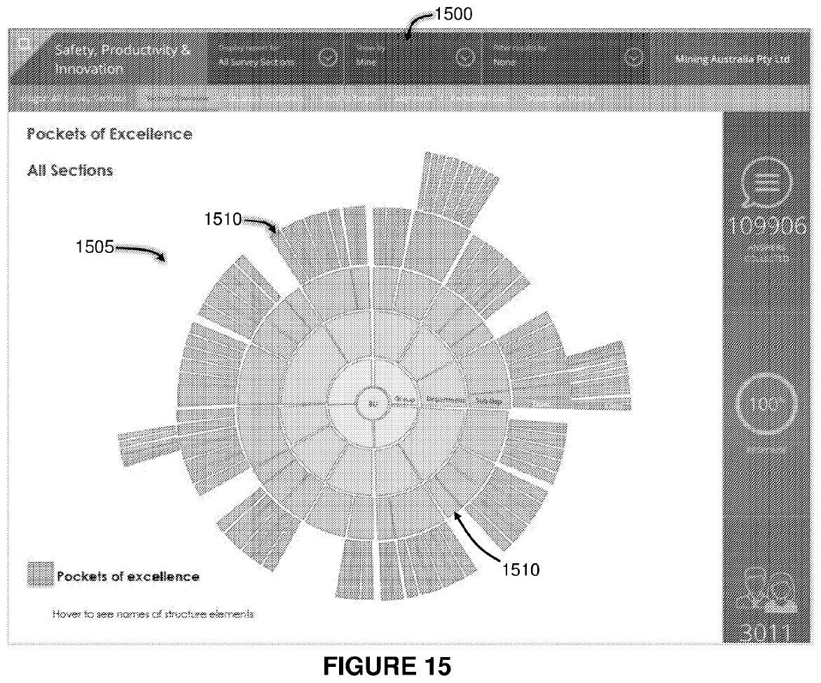

FIG. 15 illustrates a screenshot 1500 pockets of excellence screen, according to an embodiment of the present invention.

The pockets of excellence screen comprises a multi-dimensional pie chart 1505, which includes the level of an organisation (as defined by the organisation) in this example at its highest level groups, followed by departments, sub-departments, followed by teams and then crew.

Each element 1510 of the pie charge 1505 is colour coded, to illustrate individual areas which are above average (or pockets of excellence). Each element 1510 is also selectable, enabling the user to easily pin point teams, sub-departments or departments within the organisation that score above or well-above the management target in one or more sections or questions of the questionnaire.

The identified pockets of excellence can be used to identify an exemplar team, sub-department or department within the organisation, which can be used to play a role in championing the organisational change or transformation, for example.

A questionnaire comparison/continuous improvement screen of the pockets of excellence (not pictured) may be used to show the improvement of crews, teams, departments, etc. through changes in colour of the graph.

The inverse of FIG. 15 (not pictured) may be used to show the “burning platform” or areas that require immediate attention. In such case, colour coding may be used to show the key focus areas.

A questionnaire comparison/continuous improvement screen of the “burning platform” (not pictured), may be used to show a decrease in areas that require attention.

Now turning back to FIG. 1, according to certain embodiments, the library 110 includes descriptions of actions to move from one maturity level to the next, and descriptions of benefits of moving from one maturity level to the next. This data may be provided to the manager 115 in association with the dashboard (screens) illustrated above, to ensure that the system not only evaluates where the business currently is, but also how and why to change.

According to alternative embodiments, additional graphs (user interface elements) may be provided to illustrate a depth graph of productivity and/or internal knowledge, and management level alignment (e.g. showing how the shop floor/frontline compares to management levels).

Additional applications may also be defined to provide action development per respondent/business, and illustrate the benefits derived per action/step up in maturity.

Furthermore, business rules may be defined where common denominators that are derived from the data can be used for research or commercialised for use by companies and industries.

By providing an interactive dashboard (as outlined above) that shows outcomes of the overall current situation and the ambition of the respondents in comparison to defined management targets, the manager is able to quickly and effectively identify key areas where the internal ambition is behind, on, or beyond the target. This enables the manager to more efficiently move and reallocate resources, and thus stop, continue and focus on specific areas accordingly.

As the dashboard (screens) above are interactive, the manager is able to drill down on specific areas, compare specific areas, and thus get a good view of the business, according to a wide number of variables.

The above described system enables surveys to be performed on a multitude of computers and (smart) devices, enabling the assessment of all or a large group of respondents.

By using qualitative situational aspects described by standardised maturity levels, the data is less prone to individual and group variations.

By using sliders, rather than radio buttons or checkboxes, for example, respondents are more likely to answer questions without large delays, and are able to select values that suit them best.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1-31. (canceled)

32. A dashboard configured to graphically illustrate:
A. qualitative data from a plurality of respondents in response to an electronic questionnaire including a number of multiple choice questions each with a number of answer options, each answer option associated with a particular maturity level, the dashboard configured to illustrate, reference and compare at least three points of data for each questionnaire, the at least three points of data indicative of:
a. a perceived actual situation identified by the respondents;
b. a perceived expectation of a future situation to be achieved in an agreed amount of time identified by the respondents; and
c. a target; and
B. automated, objective and unbiased qualitative insights based on the at least three points of data to provide immediate improvement actions and benefits thereof, the qualitative insights based on steps that improve the maturity level or parts thereof for each question in the questionnaire, groups of questions in the questionnaire and/or subjects in the questionnaire.

33. The dashboard of claim 32, further including:
provision of access to a library which includes a plurality of questions relating to a multitude of business areas, and a plurality of situational answer descriptions each associated with a maturity level, that comprise answers to the questions; and/or
an alignment map illustrating a distribution in data corresponding to groups of respondents; and/or,
a knowledge availability (or performance realization) map, or a knowledge gap (or performance gap) map, or a pockets of excellence map or a burning platform map for each of a plurality of sections; and/or,
a line along which averaged respondents' actual and expectation data is graphically represented, the averaged respondents' actual and expectation data averaged over a plurality of respondents, and a stacked bar chart, illustrating a distribution of respondents' actual and/or expectation data over the plurality of respondents.

34. The dashboard of claim 32, further including an actual data element, indicative of at least part of the data of the respondents' perceived actual situation, and an ambition data element, indicative of at least part of the data of the respondents' perceived expectation.

35. The dashboard of claim 34, further including a target data element, indicative of at least part of the target data.

36. The dashboard of claim 34, further including:
a data element indicative of a difference between data indicative of the perceived actual situation and/or the data indicative of the perceived ambition with reference to target data; and/or
a plurality of lines, for each of a plurality of sections, wherein the respondents' actual and expectation data is graphically presented on each of the lines according to the section associated with the data.

37. The dashboard of claim 35, further including a line along which the respondents' actual, ambition and target data is graphically represented, the line representing a scale on which the actual, expectation and target data is compared.

38. The dashboard of claim 37, wherein:
the respondents' actual, expectation and target data are graphically represented using different shape elements; or,
the actual and expectation data are color coded according to how far the data is from the target; or,
the actual and expectation data are color coded according to how far the data is from the target, and wherein the respondents' actual and expectation data is further color coded according to whether it is above target, below target or on target.

39. The dashboard of claim 34, wherein:
the respondents' actual and expectation data is averaged over all respondents, or a subset of all respondents; or
the respondents' actual data element and/or the expectation data element includes a spread element indicating the range of answers given in relation to the data indicative of the perceived actual situation or expectation.

40. The dashboard of claim 34, including a stacked bar chart, illustrating a distribution of respondents' actual and/or expectation data with reference to target data.

41. The dashboard of claim 40, wherein:
an element of the stacked bar chart represents a number of respondents in relation to which actual data is below the corresponding target data, an element represents a number of respondents in relation to which actual data is above the corresponding target data, and an element represents a number of respondents in relation to which the actual data is in line with the corresponding target data; or
elements of the stacked bar chart represent respondents' actual and expectation data, and wherein the elements relating to respondents' actual and expectation data are interleaved in the stacked bar chart.

42. The dashboard of claim 40, comprising a plurality of stacked bar charts, wherein each of the bar charts relates to a different subset of the respondents' actual and/or expectation data respectively.

43. The dashboard of claim 42, wherein the stacked bar charts are:
displayed in an order according to the distribution; or
aligned graphically according to a difference between a distribution of respondents that are above and below the target.

44. The dashboard of claim 43, further including a situation breakdown table (or heat map) where rows represent groups of respondents, and columns represent areas, and wherein cells are provided at an intersection of rows and columns to illustrate respondents' actual and/or expectation data in relation to the associated group and area.

45. The dashboard of claim 43, wherein the cells are color coded according to a difference between the respondents' actual and/or expectation data and the target.

46. The dashboard of claim 44, wherein the cells are grouped according to respondents' actual and expectation data.

47. The dashboard of claim 32, wherein the dashboard is interactive and multi-dimensional.

48. The dashboard of claim 46, wherein a subset of respondents are selected, upon which a graphical representation of the data on the dashboard is updated accordingly.

49. The dashboard of claim 32, wherein:
the data includes data of different time periods, and the dashboard enables selective presentation of data according to the time periods; or,
the data includes data of different time periods, and the dashboard enables simultaneous and separate presentation of data corresponding to different time periods.

50. A qualitative analysis method including:
receiving qualitative data from a plurality of respondents, the qualitative data indicative of an actual situation and an expected situation relating to a plurality of areas;
receiving target data that relates to the qualitative data; and
providing a dashboard configured to graphically illustrate data indicative of the respondents' actual situation and data indicative of the expected situation with reference to the target.

51. A qualitative analysis system including a server, configured to:
receive qualitative data from a plurality of respondents, the qualitative data indicative of an actual situation and an expected situation relating to a plurality of areas;
receive target data that relates to the qualitative data; and
provide a dashboard configured to graphically illustrate data indicative of the respondents' actual situation and data indicative of the expected situation with reference to the target.
